(19) United States
(12) Patent Application Publication
(10) Pub. No.: US 2004/0231024 A1
(43) Pub. Date: Nov. 25, 2004

(54) Method for securing loose clothing around a human's waist by holding the sleeves together with a strap fastened to itself

(76) Inventors: Pamela Dawn Grisham, Lake Stevens, WA (US); Steven Mitchell Grisham, Lake Stevens, WA (US)

Correspondence Address: PAMELA GRISHAM, 722 95 DRIVE SE, LAKE STEVENS, WA, 98258, US

(21) Appl. No.: 10/798,291

(22) Filed: Mar. 12, 2004

Related U.S. Application Data
(60) Provisional application No. 60/454,414, filed on Mar. 14, 2003.

(51) Int. Cl. A62B 17/00; A62D 5/00; A41D 27/12

(52) U.S. Cl. 2/59

(57) ABSTRACT

A loose clothing holder for releasibly retaining loose clothing around a user's waist comprises a strap of material, having two sides and two ends, the strap being sufficiently flexible so that the strap may be positioned around the clothing sleeves. Preferably, the strap comprises a single layer of fabric sold under the trademark, Cordura and manufactured by E. I. du Pont de Nemours and Company Wilmington, Del. 1. The loose clothing sleeve holder has a fastening mechanism coupled to each end of the strap at opposite sides thereof. The fastening mechanism preferably comprises cooperating hook and loop fastener fabric. The loose clothing holder may also have a label coupled to the upper side of the strap which label may contain graphics or other logos. Preferably, the label comprises fabric transfer paper. The loose clothing holder may also have reflective fabric coupled to the upper side of the strap. Preferably, the reflective fabric comprises a textile fabric comprising glass spheres bonded with waterproof resign. A method of using the loose clothing holder comprises placing the strap around the sleeves of the loose clothing that has been placed around the user's waist, so that the strap is perpendicular to the user's hips where it is coupled near or at the ends by activating the fastening mechanism and with sufficient holding pressure to reasonably hold the sleeves of the garment together.

### FEDERALLY SPONSORED RESEARCH

Not Applicable

### SEQUENCE LISTED OR PROGRAM

Not Applicable

### BACKGROUND

1. Field of Invention

This invention relates to securing outer garments around a person's waist; specifically, a method for securing loose clothing around a human's waist by holding the sleeves together with a fastening strap.

2. Description of Prior Art

Adjusting a shit's sleeve for comfort is documented in U.S. Pat. No. 6,081,925 by the use of a strap for upper body clothing, through installation of a strap through user's worn shirt's sleeve and neck. The strap's function is to move the sleeve of said shirt onto the shoulder of the user. This device is notably dissimilar to the newly invented device. The dissimilarity includes but is not limited to the device being designed to be worn at the user's shoulder, on clothing that is not first removed from the user and is applied to a single sleeve in its use. U.S. Pat. No. 4,475,252 comprises a jacket having adjustable sleeves. The invented item is itself a garment with a loop on the interior of each sleeve which interacts with an epaulet on each shoulder to retain sleeves once rolled up. The epaulets are threaded through the loops and are fastened about the loops. Similarly, U.S. Pat. No. 5,692,239 is a sleeve holder for securing drawn-up sleeves by use of an epaulet strap which is secured to a shirt, at the shoulder and projects down the sleeve for the purpose of protecting the sleeve or keeping it from becoming entangled during activities. Both prior art are dissimilar as their design comprises simply moving sleeves into a more desirable position for the user and incorporates the design into the clothing. Neither combine the sleeves together to accomplish their purpose.

The currently invented device is also dissimilar to the art in U.S. Pat. No. 4,991,234 which relates to an elastic support band for encircling a portion of the wearer's body. The currently invented device is designed to encircle the sleeves of a previously worn garment and does not feature encircling the user's body. Similarity, a sports accessory device, which can be used as a towel is comprised under U.S. Pat. No. 4,698,854 and a pant leg restraining band comprises U.S. Pat. No. 4,825,475. Both prior art references wrap around at least a the users body or body part.

### OBJECTS AND ADVANTAGES

Accordingly, several objects and advantages of the present invented method:

a) a strap which can be removably used in the combination with long sleeved clothing once said clothing has been removed and placed around the user's waist;

b) hook and loop fastening device that connects to form a loop around the loose clothing's garment sleeves;

c) improvement from the requirement to tie clothing sleeves together to keep clothing around the user's waist;

d) use of the sleeves in combination; and

e) requirement of only one device for both sleeves.

### SUMMARY

In accordance with the present method for securing loose clothing around a human's waist by holding said clothing sleeves together with a fastened strap comprises material having sufficient size to accommodate use by a human being, an elongated shape and at least one layer of said material, an upper and lower side, a predetermined length to fit around said sleeves, a fastening mechanism coupled to said strap on opposite sides thereof for placement of said strap between user's waist and around said loose clothing sleeves such that said strap is substantially perpendicular to said user's waist, and fastening said strap by engaging said fastening mechanism whereby storing said clothing around the user's waist.

This application claims priority from U.S. provisional application Serial No. 60/454,414 filed on Mar. 14, 2003

### DRAWINGS

FIG. 1 is a perspective view of the loose clothing sleeve holder in use by user.

FIG. 2 is a perspective view of the loose clothing sleeve holder upper side.

FIG. 3 is a perspective view of the loose clothing sleeve holder lower side.

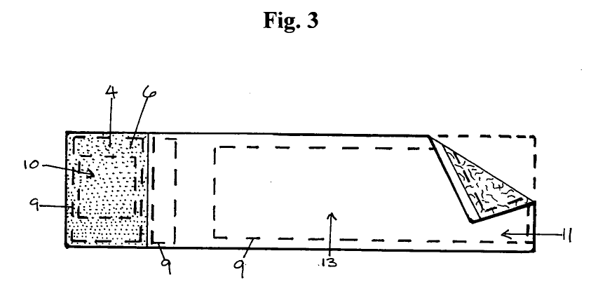

FIG. 4 is a perspective view of the loose clothing sleeve holder side view.

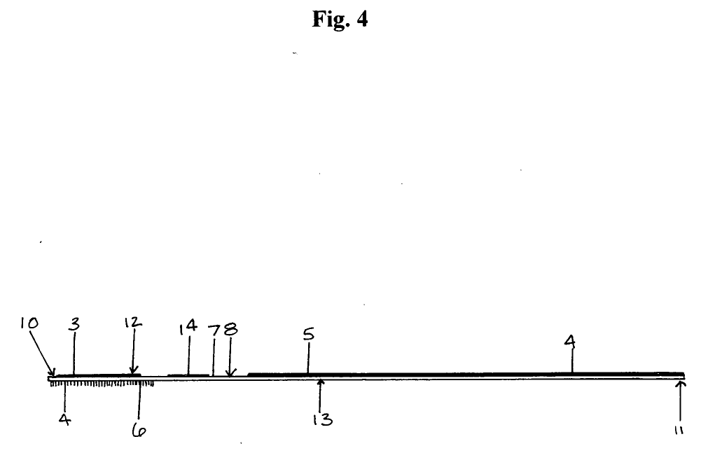

FIG. 5 is a perspective view of the loose clothing sleeve holder forming a loop.

### REFERENCE NUMERALS IN DRAWINGS

1. User

2. In place loose clothing sleeve holder

3. Label

4. Fastening mechanism

5. Female, loop fastener fabric

6. Male, hook fastener fabric

7. Material

8. Strap

9. Stitching

10. First end

11. Second end

12. Upper Side

13. Lower Side

14. Reflective fabric

15. Human body

16. Waist

17. Leg

18. Clothing

19. Loose clothing

20. Sleeves

21. Top of sleeves

22. Bottom of sleeves

### DETAILED DESCRIPTION OF THE INVENTION

This invention can be better understood by reference to the drawings. For the sake of brevity, the garment which is retained by this invention is referred to as a coat. However, it is to be understood as briefly described above that this invention can be used in cooperation with any long sleeved garment or garments.

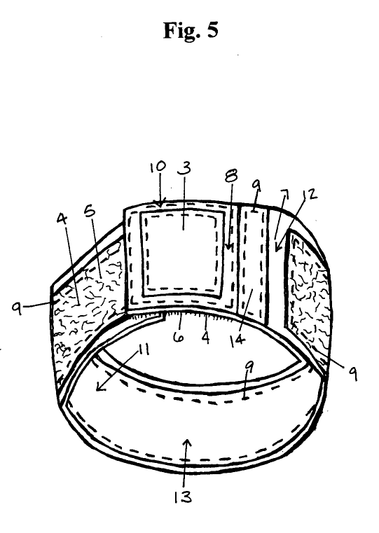

Referring now to the drawings wherein like numerals indicate like elements, there is FIG. 5 a loose clothing sleeve holder. The loose clothing sleeve holder comprises an elongated strap 8 of material 7 having an upper side 12 and a lower side 13 and a first end 10 and a second end 11. The strap 8 may be made of any material 7, fabric or textile, elasticized or non elasticized. The strap 8 may comprise a single layer or material or more than one layer of material. Suitable materials for the strap are numerous and some desirable properties include, but are not limited to, the following: durability, structural integrity, stain resistance, and flexibility. The material preferably should be sufficiently durable so as to be capable of repeated use without ripping, tearing, breaking, or otherwise failing. Also, the material preferably should be sufficiently resistant to permanent disfigurations after repeated use. This means that, upon application of tensile or torsional forces of magnitude which a human can apply to clothing sleeves without the use of tools, the material preferably should not be capable of permanent deformations. Additionally, the material preferably should be resistant to stains, soiling, fading, and the like so as to be able to retain its appearance after repeated use. The fabric should be of a surface type to lessen the amount of sleeve slippage in order to accomplish generally snug pressure against the sleeves. At the same time, the material should preferably be sufficiently flexible so that the ends 10, 11 of the strap 8 can easily be manipulated to allow the first end 10 to be positioned across the sleeves of the loose clothing while the second end 11 to be positioned under the sleeves and adjacent to the first end 10. Given these and other factors, suitable materials include substantially any textile material, polymeric materials, or other fabric which would be suitable as an accessory to clothing. In addition, a preferable feature for the material for the strap 8 is that the material be sufficiently soft or smooth so as to cause no abrasion to the user. In the preferred embodiment, the strap 8 is of a single layer of fabric sold under the trademark, Cordura and manufactured by E. I. du Pont de Nemours and Company Wilmington, Del.

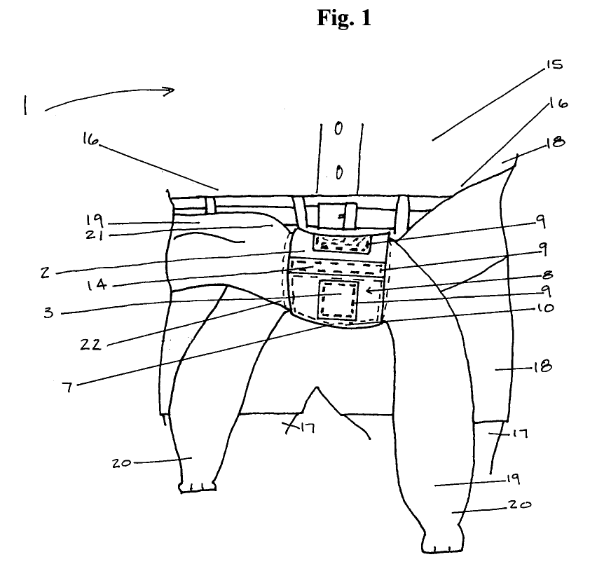

Referring now to FIG. 5 the size of the lose clothing sleeve holder loop 5 is determined by the size of the sleeve. The strap 8 may be of various lengths and widths, depending on several factors. Some of these factors include but are not limited to, the following: the activity engaged in by the user FIG. 1 the gender of the user FIG. 1, the physical size of the user FIG. 1, and the personal preferences of the user FIG. 1. For instance, a male might prefer a wider or longer loose clothing sleeve holder than might a female or child. Similarly, a person engaged in an activity which requires frequent and strenuous body movements (like, for instance, jogging or running) might prefer a shorter or smaller loose clothing sleeve holder FIG. 5 than would a leisure activity which requires only small body movements (like, for instance, walking or riding an animal). It should be noted that possible size ranges of the strap 8 also depend on the type of material used for the strap 8. A strap 8 of a material which has a high yield strength might be functionally capable of a narrower width than strap 8 of a material which has a lower yield strength. In the preferred embodiment, the strap 8 measures approximately 8 inches by approximately 3 inches long.

A fastening mechanism 4 comprises a male member 6 and a cooperating female member 5. The fastening mechanism 4 may be of any type commonly known art. It is to be noted that the functional requirements of the loose clothing sleeve holder FIG. 5 require only that the male member 6 and the female member 5 be engaged. Typically, the fastening mechanism 4 is coupled to alternate sides 12 of the strap 13 at opposite ends 10, 11 of the strap 8 or anywhere along the female member 5. This arrangement allows the male member 6 to engage the female member 5 so that the loose clothing sleeve holder FIG. 5 thereby forms a loop securing sleeves to the desired tension The fastening mechanism 4 can overlay substantially the length of the strap 8, or only a portion thereof. In the preferred embodiment, the fastening mechanism 4 comprises cooperating strips of hook and loop fastener fabric, wherein the male member 6 is a strip of hook fabric, and the female member 5 is a strip of loop fabric. Also, in the preferred embodiment the female member 5 extends substantially the length of the strap 8 for adjustability.

In the preferred embodiment, the male member 6 and the female member 5 are coupled to alternate sides 12, 13 of strap 8 at opposite ends 10, 11 thereof. It should be noted that the loose clothing sleeve holder will function properly whenever the male member 6 and the female member 5 are coupled.

The length of the loose clothing sleeve holder FIG. 5 is adjustable so as to adjust the size of the loop FIG. 5 formed by joining first end 10 and anywhere on the female fabric 5 . Adjustability of the loose clothing sleeve holder FIG. 5 can be beneficial to the user FIG. 1 to better retain loose clothing sleeves of various materials, sizes and weights. Generally, the longer the fastening mechanism 4, the more adjustable the loose clothing sleeve holder FIG. 5. In the preferred embodiment, the length of the male member 6, the female member 5, or both, may be altered to provide an adjustment to shorten or lengthen the loop formed by the connection of male member 6, and female member 5. Specifically, in the preferred embodiment, the female member 5 is more elongated that is the male member 6. More specifically in the preferred embodiment, the female member 5 measures approximately 6.5 inches in length whereas the male member 6 measures approximately 2 inches in length. The added length of the female member 5 provides the user FIG. 1 with adjustability substantially similar to the length of the female member 5.

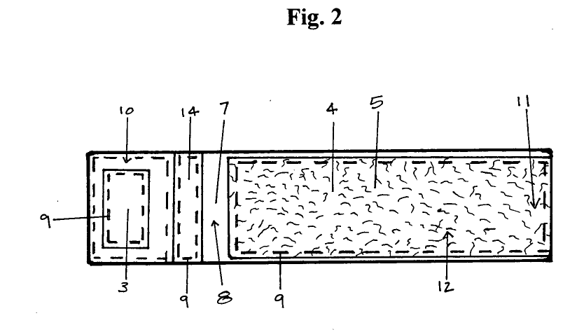

Referring now to FIG. 2 a label 3 may be coupled to the strap 8 and disposed on the upper side 12 thereof and/or reflective fabric 14 may be coupled to the strap. The label 3 may be of substantially any material in any color. The reflective fabric 14 may be substantially any material in any color as well. The method of coupling the label 3, and/or reflective strip 14 to the strap 8 may be any method known in the art for the particular materials used for the strap 8, the label 3 and/or reflective fabric 14. Suitable methods of coupling can include mechanical processes (for instance where some structure is utilized to hold the label 3 and/or reflective fabric 14 to strap 8); chemical processes (for instance, where at least on chemical compound is used to adhere the label 3 and/or reflective fabric 14 to the strap 8); and physical processes (for instance, where a physical force is used to join the label 3 and/or reflective fabric 14 to the strap 8). The label 3 may contain graphics which pertains to any clothing for which the user FIG. 1 might utilize the loose clothing sleeve holder FIG. 5. In addition, the label 3 may contain graphics which refer to products, services, manufacturers, advertising, and the like. The reflective fabric 14 and label 3 may completely overlay the strap 8, or may overlay only a portion of the strap 8.

The label 3 preferably should be made of a material which is not irritative or abrasive to the user FIG. 1. In the preferred embodiment, the label 3 is of heat transfer paper which and the label is coupled to the strap by heated contact and further coupled by sewing.

Also in the preferred embodiment, the graphics are coupled to the label by mechanical printing.

In the preferred embodiment, the reflective fabric 14 is comprised of a textile fabric comprising glass spheres bonded with waterproof resign. The reflective fabric 14 is coupled with the strap 8 by sewing.

FIG. 1 illustrates a loose clothing sleeve holder FIG. 5 of the present invention as it appears when worn by the user. FIG. 1 depicts only a partial perspective view of user 1 and indicates, generally, a human body 15, waist 16, leg 17, outer clothing 18, loose clothing 19, loose clothing sleeves 20 and in-use loose clothing sleeve holder 2.

One method of using the loose clothing sleeve holder FIG. 1 begins with the user 1 placing the loose clothing around waist of the user 1. The user 1 inserts the loose clothing sleeve holder between the sleeves of the loose clothing 19, and the user's waist, generally perpendicular to the sleeves 19. The upper side 12 of strap 8 faces the user 1; the strap 8 is elongated in a direction substantially perpendicular to the sleeves 20. The user 1 then connects first end 10 by activating the fastening mechanism 4. In the preferred embodiment, the user 1 releasibly attaches the first end 10 by mating the male member 6 with the female member 5 thereby encircling sleeves 20 with the desired tension, resulting in a loop FIG. 5. The resulting loop FIG. 5 remains reasonably attached until the user 1 is ready to remove the loose clothing sleeve holder FIG. 5. When installed in this manner, the label 3 or graphics in which the orientation is irrelevant in order for observers to comprehend the effect of the label 3 or of the graphics. In these cases, it is irrelevant whether the first end 10 or the second end 11 is toward the top 21 of the loose clothing sleeves 20 or the bottom 22 of the loose clothing sleeves 20. It should be recalled that any method of attaching the strap 8 to itself would be functionally acceptable so long as sleeves 19 are encircled.

The loose clothing sleeve holder FIG. 5 can be easily manufactured in various ways depending on the materials selected for the strap 8, the fastening mechanism 4, and the label 3, if any. Manufacturing the loose clothing sleeve holder FIG. 5 comprises generally, assembling the various component parts. In the preferred embodiment, a label 3 is prepared with the desired graphics, if any, by mechanical printing or silk screening. The reflective strip 14, is sized according to preference so that is overlays end 10, between the label 3 and the female fastener 5. The reflective strip is substantially parallel to the end cut of the material 7 and coupled to the strap by sewing 9. The label 3 is sized according to preference so that the label 3 overlays partially end 10. The male member 6 is placed at the preferred end 10 and the female member 5 is placed at the alternate end 11 and on the opposite surface 13 as the male 6 member. The loose clothing sleeve holder is then sewn 9 around the label 3 perimeter to secure it to the strap 8. The male member 6 is sewn 9 around its perimeter to couple it to strap 8 as is the female member 5 sewn around its perimeter to secure it to strap 8.

While the invention has been described with reference to specific embodiments, modifications and variations of the invention may be constructed without departing from the scope of the invention which is defined claims.

1. A method for securing loose clothing around a human's waist by holding said clothing sleeves together with a fastened strap. Said strap comprising:
a) material having sufficient size to accommodate use by a human being,
b) an elongated shape and at least one layer of said material,
c) an upper and lower side, wherein said upper and lower sides are relatively smooth uninterrupted surfaces,
d) predetermined length to fit around said sleeves,
e) a fastening mechanism coupled to said strap on opposite sides thereof and where neither of said fastening mechanism traverses the entire length of said strap,
f) placement of said strap between user's waist and around said loose clothing sleeves such that said strap is substantially perpendicular to said user's waist,
g) fastening of said strap by engaging said fastening mechanism.

2. The method for securing loose clothing sleeves is recited in claim 1 wherein said strap further comprises a label coupled to said upper side of said strap.

3. The method for securing loose clothing sleeves is recited in claim 1 wherein said material further comprises a textile fabric.

4. The method for securing loose clothing sleeves is recited in claim 1 wherein said material further comprises fabric.

5. A method for holding loose clothing around a user's waist by holding said clothing sleeves together with an article not attached to said clothing.
